(19) United States
(12) Patent Application Publication
(10) Pub. No.: US 2005/0053349 A1
(43) Pub. Date: Mar. 10, 2005

(54) Waveguide photodetector

(76) Inventors: Jung Woo Park, Seoul (KR); Yong Soon Baek, Daejon-Shi (KR)

Correspondence Address: JACOBSON HOLMAN PLLC, 400 SEVENTH STREET N.W., SUITE 600, WASHINGTON, DC, 20004, US

(21) Appl. No.: 10/733,235

(22) Filed: Dec. 12, 2003

(30) Foreign Application Priority Data
Sep. 6, 2003 (KR) 2003-62414

(51) Int. Cl. G02B 6/10

(52) U.S. Cl. 385/131

(57) ABSTRACT

The present invention relates to a waveguide photodetector having a good efficiency of coupling with an optical fiber or a PLC (Planar Light-wave Circuit). In order to increase size of mode beam and to effectively receive light from the optical fiber or the PLC, a thin absorbing layer is used as a core and a semiconductor having an index of refraction similar to that of the absorbing layer is used as a cladding layer. By doing so, it is possible to obtain a good efficiency of coupling with an optical fiber or a PLC. In addition, since a little amount of light proceeds along a waveguide, it is possible to obtain high operating speed even under a high power. Furthermore, by reducing difference between indexes of refraction of the absorbing layer and the cladding layer, it is possible to suppress the “carrier-trapping” generated from small difference between band gaps of the two materials.

### BACKGROUND

1. Field of the Invention

The present invention relates to a waveguide photodetector, and more specifically, a waveguide photodetector having a good efficiency of coupling with an optical fiber or a PLC (Planar Light-wave Circuit) and being capable of operating at a high speed under a high input power.

2. Discussion of Related Art

The photodetector that converts an optical signal into an electrical signal is mainly manufactured with a semiconductor for which various kinds of semiconductor materials are used depending on usage of the photodetector. The photodetector manufactured with the semiconductor has a semiconductor absorbing layer which generates electrons and holes. The electrons and holes are moved into the respective electrodes to generate the electrical signal.

As an example, there is a PIN diode photodetector. When a reverse voltage is applied to the photodetector, electrons and holes, that is, charges are generated and moved into an n-electrode and a p-electrode, respectively. The operating speed of the PIN diode depends on time of the generated charges moving into the respective electrodes, that is, a transit time, and the so-called RC effect which is derived from capacitance of the PIN diode and load resistance. In order to obtain a high operating speed, it is necessary to reduce the transit time and the capacitance. If the absorbing layer is formed to be thin, the transit time may be reduced. However, reduction of the thickness of the absorbing layer leads to the increase of the capacitance. Therefore, the thickness of the absorbing layer needs to be adjusted in accordance with its usage.

In general, a waveguide photodetector is integrated with an optical device such a PLC. The waveguide photodetector advantageously has a higher operating speed and higher efficiency than a surface illumination photodetector which is generally used. For these advantages, many kinds of side illumination waveguide photodetectors have been developed.

In order to improve the efficiency of the waveguide photodetector, it is important to increase the so-called coupling efficiency between the waveguide photodetector and an optical fiber or a PLC. The light beam emitted from the optical fiber or the PLC typically has a large diameter of 7 to 10 μm. There are difficulties in manufacturing a semiconductor waveguide capable of effectively propagating the light beam having such a large diameter.

As an approach for effectively propagating a large intensity of light, a multiple mode waveguide photodetector is proposed in an article titled ”a high efficiency 50 GHz InGaAs multimode waveguide photodetector,” IEEE J. of Quantum Electronics, vol. 28, No. 12, pp.2728-2735 (1992).

FIG. 1 is a cross-sectional view for explaining a conventional waveguide photodetector. As shown in FIG. 1, an SCH (Separate Confinement Hetero-structure) layer 3, an absorbing layer 1, an SCH layer 2, and a cladding layer 4 are sequentially formed on a cladding layer 5. And then, the cladding layer 4, the SCH layer 2, the absorbing layer 1, the SCH layer 3, and the cladding layer 5 are etched up to the respective predetermined thicknesses. In the photodetector, incident light is not only confined in the absorbing layer 1 made up of InGaAs, but spreads over the absorbing layer 2 made up of p-InGaAsP and the absorbing layer 3 made up of n-InGaAsP, which are provided at both sides of the absorbing layer 1. Therefore, it is possible to detect and propagate light having a large mode size.

However, it is difficult to manufacture such a structure because it is deeply etched. Practically, in order to manufacture a photodetector capable of effectively coupling a silica PLC, it is necessary to etch layers of more than 5 μm in the structure of FIG. 1. In addition, since the InGaAs absorbing layer 1 is thick, a large portion of incident light is confined in the InGaAs absorbing layer 1. Accordingly, when a high power of light is incident, electrons and holes are excessively generated, and voltage applied to the photodetector is reduced thereby. As a result, the operating speed is lowered. In other word, when the high power of light is incident, the operating speed is disadvantageously lowered.

Therefore, a waveguide photodetector capable of operating at a high speed even under a high input power is disclosed at the U.S. Pat. Registered No. 6,278,820 B1.

In the photodetector, a core layer 12 of a waveguide is formed on a substrate 16. A doped n+ layer 34, a doped conducting layer 24 as an intermediate layer, an absorbing layer 14, a p+ layer 35 are sequentially formed on the core layer 12. The some portions of the p+ layer 35, the absorbing layer 14, the conducting layer 24, and the n+ layer 34 are patterned to form a rib structure. On the patterned absorbing layer 14, respective electrodes 18 and 36 are provided.

In the aforementioned structure in FIG. 2, the light is propagated mainly through the core layer 12 of the waveguide which is formed below the absorbing layer 14, and a little amount of light is trapped into the absorbing layer 14. Accordingly, even though a large intensity of light is incident, a little electrons and holes are generated in the absorbing layer 14, so that reduction of the operating speed which occurs at the structure in FIG. 1 can be prevented.

On the other hand, in order to propagate light having a large mode size, the waveguide need to be formed in a large size. In case of the structure in FIG. 1, a large amount of etching is necessary. However, in case of the structure in FIG. 2, the light having a large mode size can advantageously be propagated with even a small amount of etching. In the structure in FIG. 2, in addition to the core layer 12 which functions as a main waveguide, the absorbing layer 14 and an intermediate layer 24 are provided to form one waveguide with the core layer 12. Therefore, a central axis of a waveguide mode is not coincident with the center of the core layer 12, so that the central axis may be accurately located. Therefore, when the waveguide photodetector is integrated with the PLC, its central axis is difficult to be accurately located, so that the effective coupling with the PLC may be difficult.

### SUMMARY OF THE INVENTION

In order to solve the aforementioned problems, the present invention is directed to a waveguide photodetector in which a thin absorbing layer is used as a core and a semiconductor having an index of refraction similar to that of the absorbing layer is used as a cladding layer.

In order to achieve the object of the present invention, a waveguide photodetector according to the present invention is characterized in that the waveguide photodetector comprises lower and upper cladding layers; an absorbing layer for functioning as a core layer of a waveguide, the absorbing layer being provided between the lower and upper cladding layers; and an spacer being provided between the absorbing layer and the lower cladding layer, the spacer having a band gap which is higher than that of the absorption and is lower than that of the lower cladding layer, the spacer having an index of refraction which is similar to that of the absorbing layer and is equal to or higher than that of the lower cladding layer.

In the waveguide photodetector according to the present invention, the absorbing layer may be formed in a thickness of 0.2 μm or less to have a wide distribution of light intensity and made up of a material of which difference of the index of refraction from that of the upper cladding layer is less than 0.2.

In the waveguide photodetector according to the present invention, the spacer may be made up of a material which is the same as that of the lower cladding layer, and the band gaps of the spacer and the absorbing layer may be adjusted to obtain a desired operating speed.

The conventional waveguide photodetector has the problem that it is difficult to manufacture the waveguide photodetector due to the corresponding excessive etching. In addition, it has the problems that the operating speed is lowered under a high input power and it is difficult to select a central axis during a process for integrating the photodetector with the PLC. The present invention provides a waveguide photodetector solving these problems and having a high operating speed and a high efficiency.

### BRIEF DESCRIPTION OF THE DRAWINGS

The aforementioned aspects and other features of the present invention will be explained in the following description, taken in conjunction with the accompanying drawings, wherein:

FIG. 1 is a cross-sectional view for explaining a conventional waveguide photodetector;

FIG. 2 is a cross-sectional view for explaining a conventional waveguide photodetector;

FIG. 3 is a cross-sectional view for explaining a waveguide photodetector according to the present invention; and

FIG. 4 is a view illustrating a distribution of light in y-axis of the structure in FIG. 3.

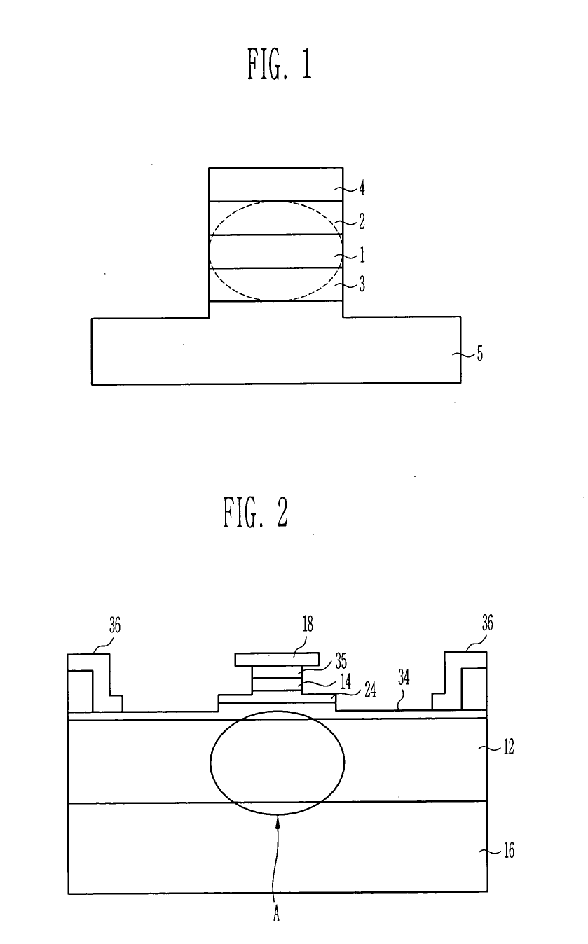

### DETAILED DESCRIPTION OF PREFERRED EMBODIMENTS

Now, the preferred embodiments of the present invention will be described in detail with reference to the accompanying drawings.

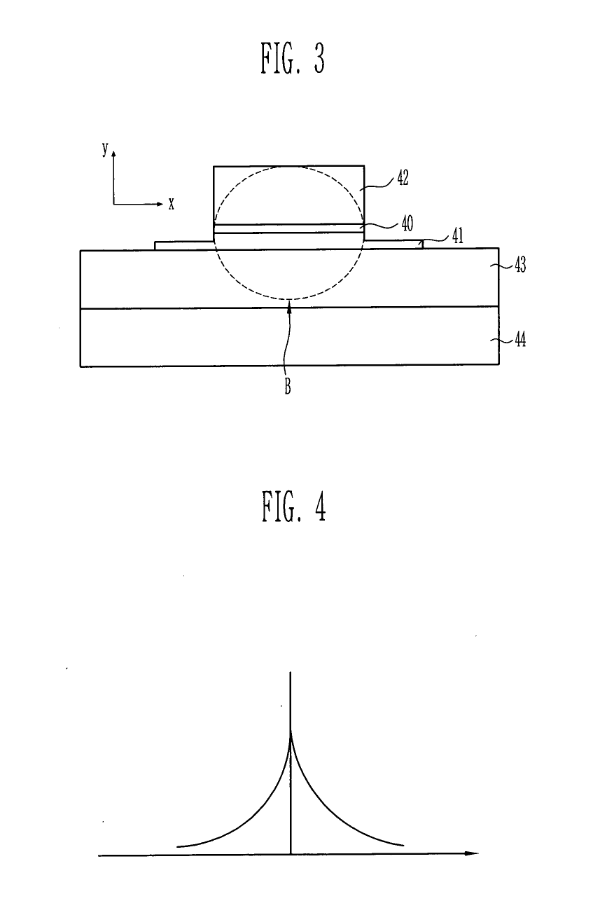

FIG. 3 is a cross-sectional view for explaining a waveguide photodetector according to the present invention.

An n-cladding layer 43, a non-doped spacer 41, an absorbing layer 40, and a p-cladding layer 42 are sequentially formed on a substrate 44. Predetermined portions of the p-cladding layer 42, the absorbing layer 40, and the spacer 41 are etched up to some depths, respectively. At that time, the depths of etching are adjusted, so that the central axis of light can be coincident with the central axis of the absorbing layer 40.

Band gap of the spacer 41 is larger than that of the absorbing layer 40 and smaller than or equal to that of the n-cladding layer 43. Index of refraction of the spacer 41 is approximately equal to that of the absorbing layer 40 and larger than or equal to that of the n-cladding layer 43. The absorbing layer 40 is formed to be so thin that intensity of the propagating light can have such a wide distribution along the axis of y in FIG. 4. In addition, the absorbing layer 40 is made up of a material having a difference of the index of refraction from the p-cladding layer 42 of less than 0.2. The spacer 41 is made up of the same material as the n-cladding layer 43, so that the electrical charge trapping can be reduced to facilitate optical propagation of light.

As described above, according to the present invention, the band gap of the spacer 41 is formed to be larger than that of the absorbing layer 40. When the band gap of the spacer 41 is larger than that of the absorbing layer 40, the index of refraction of the absorbing layer 40 becomes larger than that of the spacer 41. Therefore, the absorbing layer 40 can function as a core layer of the optical waveguide. In addition, when the band gap of the spacer 41 is large, there are conduction band discontinuity and valence band discontinuity at the junction between the spacer 41 and the absorbing layer 40. These discontinuities prevent the electrons and holes from moving to the n-cladding layer 43 and the p-cladding layer 42, so that the operating speed of the photodetector may be lowered. In case of the holes, the operating speed of the photodetector is further severely lowered. A photodetector operating at the wavelength range of 1.3 μm to 1.55 μm, which is used for optical communication, comprises the absorbing layer made up of InGaAs and the spacer made up of InGaAsP or InP. In these materials, the valance band discontinuity further dominates the conduction band discontinuity. Therefore, the electrons passing through the conduction band discontinuity is less interrupted than the holes passing through the valence band discontinuity. In addition, since the effective mass of the electron is smaller than that of the hole, the electron is able to overcome the band discontinuity and move into the corresponding electrode. For these reason, in the present invention, the spacer 41 is provided between the absorbing layer 41 and the n-cladding layer 43 to adjust the operating speed by using the difference of the band gaps between the spacer 41 and the absorbing layer 40.

In the present invention, the absorbing layer 40 functioning as the core layer is formed to having a depth of, for example, 0.2 μm or less. The approach for widening the distribution of the intensity of light by forming a thin absorbing layer 40 is well know in the process for manufacturing a mode size converter of a laser diode. In such a structure, the mode of optical waveguide is formed as indicated by an ellipsis (B portion) in FIG. 3. Therefore, according to the approach, the photodetector can be designed to correspond to the beam size of the optical fiber or the PLC, so that the effective coupling with the optical fiber or the PLC can be obtained.

If the absorbing layer 40 is formed to be thin as described above, a small portion of incident light is trapped into the absorbing layer 40, a little absorption of the propagated light is made very slowly. As a result, since a large number of electrons and holes are generated in a narrow region, electric field applied to the photodetector is reduced, and thus, the operating speed can not be lowered. However, if the absorbing layer 40 is formed to be thin, the capacitance of the photodetector is increased. In order to compensate for the increase in the capacitance, the non-doped spacer 41 is formed below the absorbing layer 40. In other words, the spacing is increased by interposing the non-doped layer between the p-cladding layer 42 and the n-cladding layer 43 to reduce the capacitance, so that the increase in the operating speed can be obtained. At that time, the spacer layer 41 is not formed at the side of the p-cladding layer 42 for the purpose of preventing the “hole trapping.”

As described above, according to the present invention, since light having a large mode size can be propagated by using a thin absorbing layer as a core and by using a semiconductor having an index of refraction similar to that of the absorbing layer as a cladding layer, it is possible to obtain a good efficiency of coupling with an optical fiber or a PLC. In addition, since a little amount of light proceeds along a waveguide, it is possible to obtain a high operating speed even under a high power. Furthermore, by reducing difference between indexes of refraction of the absorbing layer and the cladding layer, it is possible to suppress the “carrier trapping” generated from small difference between band gaps of both of the materials.

1. A waveguide photodetector comprising:
lower and upper cladding layers;
an absorbing layer for functioning as a core layer of a waveguide, the absorbing layer being provided between the lower and upper cladding layers; and
an spacer being provided between the absorbing layer and the lower cladding layer, the spacer having a band gap which is higher than that of the absorbing layer and is equal to or lower than that of the lower cladding layer, the spacer having an index of refraction which is similar to that of the absorbing layer and is equal to or higher than that of the lower cladding layer.

2. The waveguide photodetector according to claim 1,
wherein the absorbing layer is formed in a thickness of 0.2 μm or less to have a wide distribution of light intensity, and
wherein the absorbing layer is made up of a material of which difference of the index of refraction from that of the upper cladding layer is less than 0.2.

3. The waveguide photodetector according to claim 1, wherein the spacer is made up of a material which is the same as that of the lower cladding layer.

4. The waveguide photodetector according to claim 1, wherein the band gaps of the spacer and the absorbing layer are adjusted to obtain a desired operating speed.
